(19) United States
(12) Patent Application Publication
(10) Pub. No.: US 2017/0332394 A1
(43) Pub. Date: Nov. 16, 2017

(54) HetNet Interference Coordination

(71) Applicant: VODAFONE IP LICENSING LIMITED, Newbury, Berkshire (GB)

(72) Inventor: Zhanhong LU, London (GB)

(73) Assignee: VODAFONE IP LICENSING LIMITED, Newbury, Berkshire (GB)

(21) Appl. No.: 15/529,824

(22) PCT Filed: Nov. 26, 2015
(86) PCT No.: PCT/EP2015/077809

§ 371 Date: May 25, 2017

(30) Foreign Application Priority Data
Nov. 28, 2014 (GB) 1421203.9

(51) Int. Cl. H04W 72/12; H04W 24/02; H04W 84/18; H04W 72/04; G06F 9/06

(52) U.S. Cl. CPC H04W 72/1263; H04W 84/18; H04W 72/0486; H04W 24/02; G06F 9/06

(57) ABSTRACT

A self-organizing network engine for optimizing a telecommunications network is described. The telecommunications network may be a heterogeneous network with different hierarchical layers, such as macro cells and small cells. For example, the telecommunications network may include a macro cell with a small cell located inside the macro cell. The self-organizing network engine is configured to obtain traffic data describing traffic in the macro cell and in the small cell. The traffic data provides an indication of the load on each of the macro cell and the small cell and can be used to determine, for example, if the macro cell is overloaded and user devices need to be offloaded to the small cell. The self-organizing network engine is configured to determine one or more almost blank sub-frames to be reserved in a transmission schedule depending on the traffic data, and to command the base stations of the macro cell and small cell to transmit data to and from user devices at the edge of the small cell using the almost blank sub-frames, and to transmit data to and from user devices in the macro cell and in the center of the small cell using sub-frames other than the almost blank sub-frames. By reserving almost blank sub-frames for the small cell edge users, interference between the macro cell and the small cell is mitigagted. The extent to which interference between the macro cell and the small cell is mitigated is thereby controlled by a self-organizing network engine in dependence on the load on the macro cell and small cell.

### BACKGROUND

Management and control of telecommunications networks is an ongoing problem. This problem is made more complex by increasing demands on network infrastructure, especially for example in urban areas where the density of user equipment is high and demands for data and other cellular services are increasing.

Heterogeneous network topologies have been introduced in which small cells are deployed inside macro cells to provide coverage for local hotspots or holes in coverage. If the macro cell is particularly overloaded, user equipment devices near the small cell can be offloaded to the small cell by increasing the apparent radius of the small cell. The apparent radius is increased by artificially presenting the receiving power at the user equipment as being higher than it really is. This is achieved by adding a power offset to a reference signal received power that the user equipment receives from the small cell. This technique, called cell range expansion (CRE), allows the user equipment to be served by a cell with a weaker receiving power, thereby enabling offloading from the overloaded macro cell.

However, deploying a small cell inside a macro cell in the same frequency band as the macro cell leads to problems of interference between the small cell and the macro cell for user equipment at the small cell edge. This is especially true for user equipment at the edge of an expanded small cell because the receiving power of the interfering macro cell is higher than the receiving power of the small cell.

A known technique for mitigating interference between a macro cell and a small cell is to reserve certain timeslots for transmissions to and from the small cell edge users. In enhanced inter cell interference coordination (eICIC), almost blank sub-frames (ABSs) are reserved for communicating with user equipment at the edge of the small cell. Thus, for the macro cell and the center of the small cell, only pilot channel data is transmitted during the reserved sub-frames, and no data or control channel data are transmitted that might otherwise cause interference. The ABS frames are reserved only for small cell edge users to transmit or receive data. This helps to mitigate interference at the small cell edge. However, in static eICIC the ABS pattern is generally fixed so resources might be taken away from the macro cell and the small cell center unnecessarily if there are very few user equipment devices at the small cell edge.

To account for this, another approach adjusts the transmission schedule dynamically based on load data. This requires an X2 interface between the macro cell base station and the small cell base station so that they can exchange load data and dynamic ABS allocation and CRE power offset values. However, in many telecommunications networks there is not always a direct X2 interface between a macro cell and a small cell due to Internet protocol (IP) security restrictions. Furthermore, even if there is an X2 interface, latency on the X2 interface limits the granularity of ABS assignment, making it more challenging to adjust transmissions dynamically according to real time traffic.

It is an aim of the invention to provide an improved technique for management and control of telecommunications networks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A self-organizing network engine for optimizing a telecommunications network is described. The telecommunications network may be a heterogeneous network with different hierarchical layers, such as macro cells and small cells. For example, the telecommunications network may include a macro cell with a small cell located inside the macro cell. The self-organizing network engine is configured to obtain traffic data describing traffic in the macro cell and in the small cell. The traffic data provides an indication of the load on each of the macro cell and the small cell and can be used to determine, for example, if the macro cell is overloaded and user devices need to be offloaded to the small cell. The self-organizing network engine is configured to reserve one or more almost blank sub-frames depending on the traffic data, and to command the base station of the small cell to transmit data to and from user devices at the edge of the small cell using the almost blank sub-frames, to command the base station of the macro cell to transmit data to and from user devices in the macro cell using sub-frames other than the almost blank sub-frames, and to command the base station of the small cell to transmit data to and from user devices in the center of the small cell using sub-frames other than the almost blank sub-frames. By reserving almost blank sub-frames for the small cell edge users, interference between the macro cell and the small cell is mitigated. The extent to which interference between the macro cell and the small cell is mitigated is thereby controlled by a self-organizing network engine in dependence on the load on the macro cell and small cell.

A first aspect provides a self-organizing network engine for optimizing a telecommunications network. The telecommunications network comprises a macro cell, a small cell located inside the macro cell, and the self-organizing network engine. The self-organizing network engine is configured to obtain traffic data describing traffic in the macro cell and in the small cell and to determine one or more almost blank sub-frames to be reserved in a transmission schedule in dependence on the traffic data. The self-organizing network is also configured to command the telecommunications network to transmit data between a base station of the small cell and cell edge users of the small cell in the almost blank sub-frames, transmit data between a base station of the macro cell and users of the macro cell in sub-frames other than the almost blank sub-frames, and transmit data between the base station of the small cell and cell center users of the small cell in sub-frames other than the almost blank sub-frames.

A second aspect provides a method of optimizing a telecommunications network comprising a macro cell and a small cell located inside the macro cell. The method comprises, at a self-organizing network engine of the telecommunications network, obtaining traffic data describing traffic in the macro cell and in the small cell and determining one or more almost blank sub-frames to be reserved in a transmission schedule in dependence on the traffic data. The method also comprises commanding the telecommunications network to transmit data between a base station of the small cell and cell edge users of the small cell in the almost blank sub-frames, transmit data between a base station of the macro cell and users of the macro cell in sub-frames other than the almost blank sub-frames, and transmit data between the base station of the small cell and cell center users of the small cell in sub-frames other than the almost blank sub-frames.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram illustrating a macro cell and four small cells of a telecommunications network;

FIG. 2 is a sketched graph illustrating two different boundaries of a small cell in cell range expansion;

FIG. 3 is a schematic diagram illustrating an example relationship between the transmission schedules of a macro cell and a small cell using almost blank sub-frames;

FIG. 4 is a schematic diagram of a telecommunications network having a self-organizing network engine according to an embodiment of the invention;

FIG. 5 is a schematic diagram illustrating how to obtain real time telecommunications traffic data according to an embodiment of the invention;

FIG. 6 is a flow chart of a method performed by a self-organizing network engine in accordance with an embodiment of the invention; and

FIG. 7 is a schematic diagram of a computing device implementing a self-organizing network engine in accordance with an embodiment of the invention.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The inventors have found that it is possible to improve management and control of a telecommunications network such that the transmission schedules of a macro cell and a small cell in the same frequency band can be coordinated without an X2 interface. In previous techniques, an X2 interface is required for the macro cell and the small cell to exchange load data and schedule data in order to coordinate their transmission schedules dynamically based on load. The inventors present a technique in which the transmission schedules of a macro cell and a small cell are coordinated by a self-organizing network (SON) engine, thereby removing the requirement of their being a direct X2 interface between the macro cell and the small cell. Since the transmission schedules are coordinated by an SON engine, many macro cells and small cells can be taken into account, creating operational efficiency especially for large scale small cell deployments. For each macro cell and small cell pair, the SON engine is configured to obtain traffic data describing traffic in the macro cell and small cell, and to determine almost blank sub-frames to be reserved in a transmission schedule in dependence on the traffic data. The SON engine then commands the telecommunications network to use the reserved almost blank sub-frames (ABSs) to transmit data between the small cell base station and user equipment at the edge of the small cell. For other user equipment, i.e. user equipment in the center of the small cell or in the macro cell, the SON engine commands the telecommunications network to transmit data using other sub-frames. By reserving an ABS pattern for the small cell edge users, interference between the macro cell and small cell is mitigated at the small cell edge. Since the ABS pattern is controlled in dependence on real-time traffic data, the extent of interference mitigation is controlled in dependence on the number of user equipment devices likely to experience interference. Thus, in cases of high traffic, more ABSs are reserved to mitigate interference for many user equipment devices, while in cases of low traffic fewer ABSs are reserved and more sub-frames remain available to the macro cell and small cell center.

A self-organizing network (SON) engine comprises computer-implemented functionality for executing an optimization algorithm which uses efficient methods to search huge numbers of combinations of possible values of parameters of a telecommunications network (such as a 2G, 3 G, 4G telecommunications network), to find solutions which are optimal according to an assessment metric. For example, the parameters include but are not limited to hand-over parameters, antenna tilt parameters, and pilot and common channels transmission power parameters. The assessment metric may comprise thresholds and or criteria to be met by telecommunications network performance data. Examples of telecommunications network performance data include but are not limited to key performance indicators such as dropped call rate and call setup failure rate. Examples of telecommunications network performance data also include service quality indicators such as mean opinion score, delay, jitter, video resolution, video delay, number of video stalls, and frequency of video stalls. Self-organizing network engine functionality may be centralized or distributed through a telecommunications network.

Optionally, the SON engine may be configured to reserve one or more almost blank sub-frames in dependence on the traffic data by: determining from the traffic data that the traffic in the macro cell is above a threshold; and reserving a corresponding number of almost blank sub-frames. Additionally or alternatively, the SON engine may be configured to optimize the number of almost blank sub-frames for reserving by using an enhanced inter cell interference coordination algorithm.

In cases of high traffic, there may be a need to offload user equipment devices from the macro cell to the small cell by expanding the apparent radius of the small cell. In view of this, the SON engine may be configured to determine a cell range expansion power offset of the small cell in dependence on the traffic data. In that case, the SON engine may be configured to determine a CRE power offset of the small cell in dependence on the traffic data by: determining from the traffic data that the traffic in the macro cell is above a threshold; and determining a corresponding CRE power offset of the small cell. Suitably, the SON engine may be configured to optimize the CRE power offset of the small cell by using a CRE algorithm.

In order to obtain the traffic data, the SON engine is preferably configured to abstract the traffic data from IP flow data of the telecommunications network. This enables the SON server to obtain high granularity real-time traffic information. Traditionally, SON algorithms are counter-based which is limited to operation support system (OSS) counter granularity having a fastest cycle of around fifteen minutes. An OSS is a computer-implemented apparatus interfacing between a SON engine and telecommunications infrastructure. This limitation is avoided by abstracting traffic data directly from IP flow data. The SON engine may be configured to receive the IP flow data from an IP probe in a core network of the telecommunications network. In that case, the IP probe may obtain the IP flow data by probing a serving gateway of the core network. Additionally or alternatively, the self-organizing network engine may obtain the IP flow data by probing a package data network gateway of the core network.

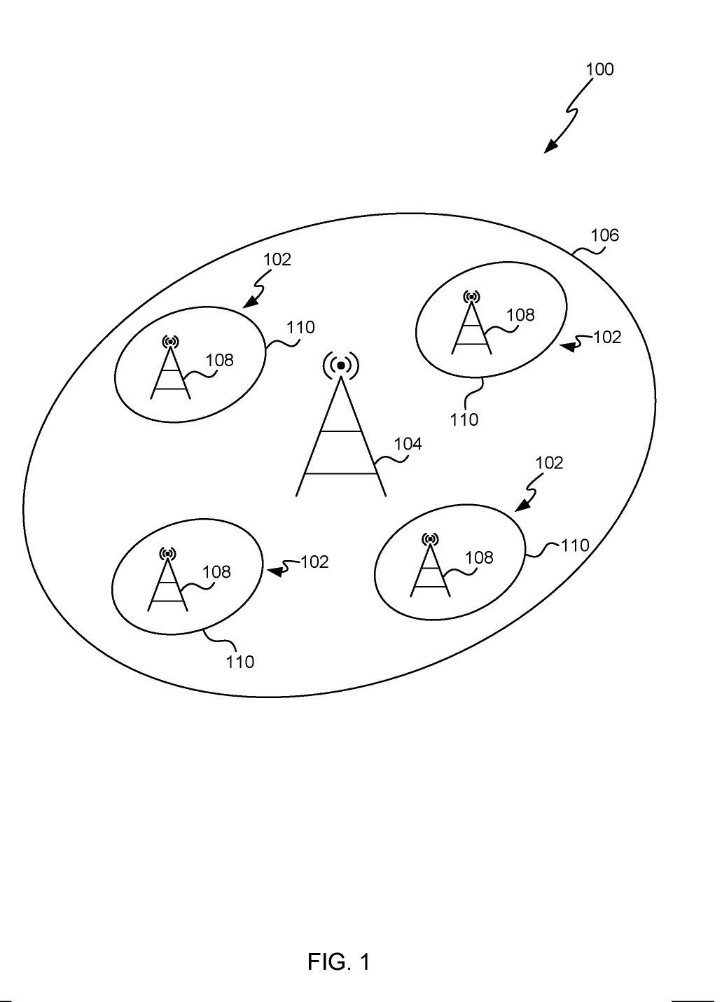

FIG. 1 illustrates a part of a telecommunications network comprising a macro cell 100 with four small cells 102 located inside the macro cell 100. A base station 104 of the macro cell transmits radio signals to user equipment devices located inside a boundary 106 of the macro cell. Small cells 102 provide coverage for local hotspots or coverage holes by transmitting radio signals from their base stations 108 to user equipment devices inside their cell boundaries 110. Inside the boundaries 110 of the small cells 102, the small cell receiving signal is higher in power than the macro cell receiving signal. Inside the boundary 106 of the macro cell 100 and outside the boundaries 110 of the small cells 102, the macro cell receiving power is higher than the small cell receiving powers.

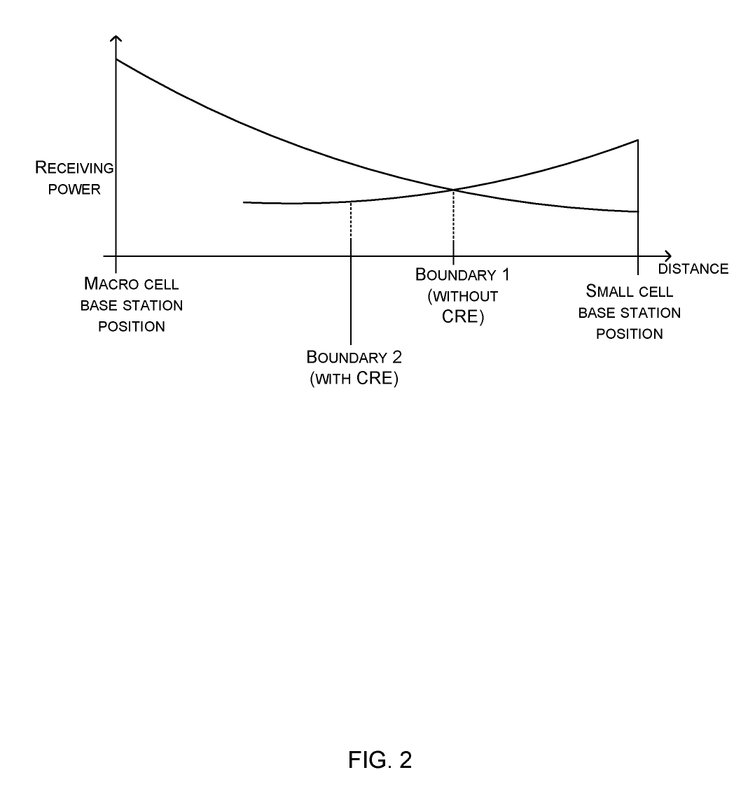

Thus, a cell boundary between the macro cell 100 and a small cell 102 may be defined by the set of locations at which a user equipment device measures equal receiving powers from each of the cells. This is boundary 1 in FIG. 2, at which the macro cell receiving power 200 is equal to the small cell receiving power 202.

If the macro cell 100 is overloaded, a CRE power offset can be added to a reference signal received power of the small cell so that user equipment devices receive an artificially inflated value of the small cell receiving power. The region in which the small cell receiving power appears to be greater than the macro cell receiving power is thereby expanded and the boundary of the small cell 201 is shifted away from the small cell base station 108 to boundary 2.

Small cells 201 help to offload user equipment devices when the macro cell 100 is overloaded but an interference problem is created at the small cell boundaries. Interference is especially bad for user equipment at the edge of an expanded small cell because the interfering receiving power is higher than the small cell receiving power.

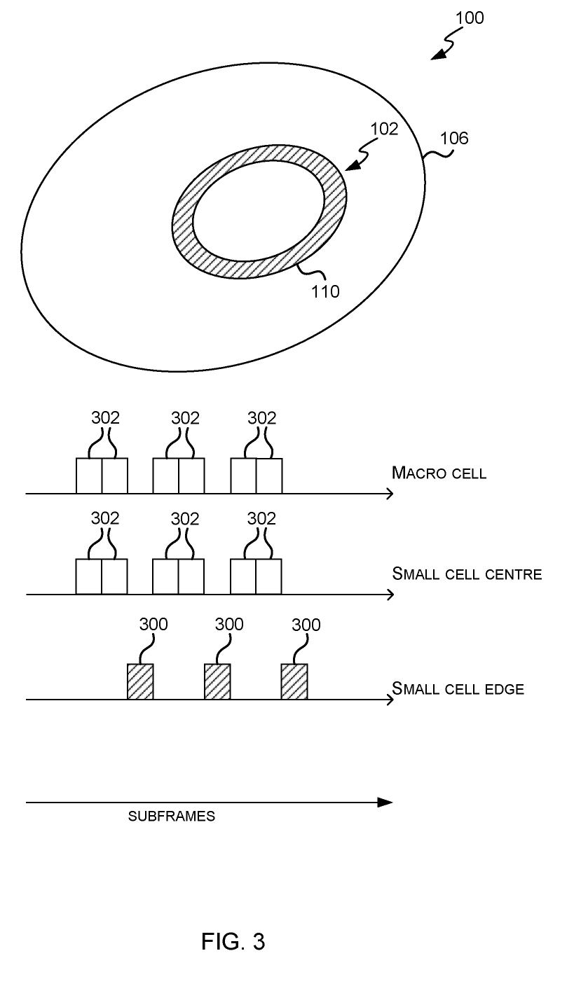

To mitigate interference, the transmission schedules of macro cells 100 and small cells 102 can be coordinated. With reference to FIG. 3, ABSs 300 may be reserved for transmissions between a small cell base station 108 and user equipment at the edge of the small cell 102. Thus, during the timeframes indicated by the ABS pattern, data is only transmitted with the small cell edge users and there are no other data transmissions to interfere with. During other sub-frames 302 data is transmitted to macro cell users and small cell center users.

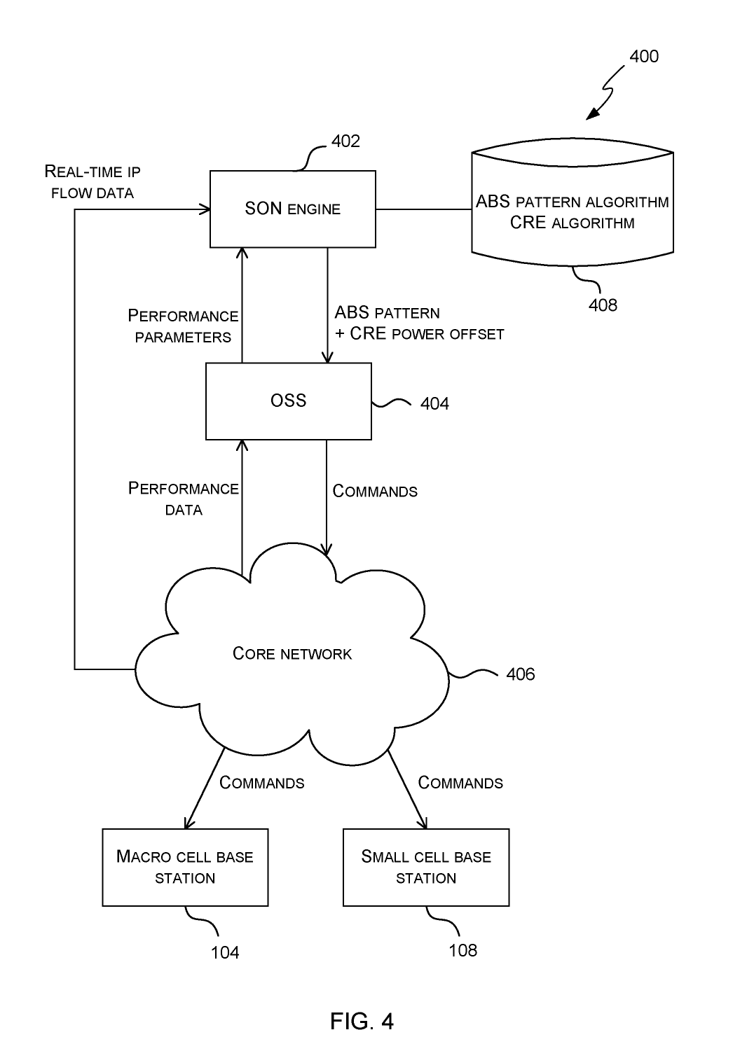

With reference to FIG. 4, a telecommunications network 400 according to an embodiment of the invention has a SON engine 402 connected to telecommunications infrastructure via an OSS 404. The telecommunications infrastructure comprises a plurality of communications network nodes such as base stations, switches and routers, connected by wired and wireless network links such as optical fiber and radio channels.

The SON engine 402 is computer-implemented using, for example, a server or a group of servers. Although the SON engine 402 is shown as being centralized, it could in other examples have distributed functionality.

The OSS 404 is configured to transmit commands to and receive network performance data from a core network 406 of the telecommunications infrastructure. The OSS 404 comprises interfaces for interoperating with various different types of telecommunications network node, such as base stations and/or other nodes in the telecommunications infrastructure. In this way the OSS 404 is able to issue commands to telecommunications network nodes in order to control the behavior of those nodes.

The core network 406 is connected to base stations of various cells of the telecommunications network 400 including macro cell base station 104 and small cell base station 108 and is configured to pass commands received from the OSS 404 to those base stations.

The SON engine 404 is configured to receive real-time IP flow data from the core network 406 and to perform ABS pattern and CRE optimization based on the IP flow data using ABS allocation and CRE algorithms which may for example be stored in a database 408 of the SON engine 402.

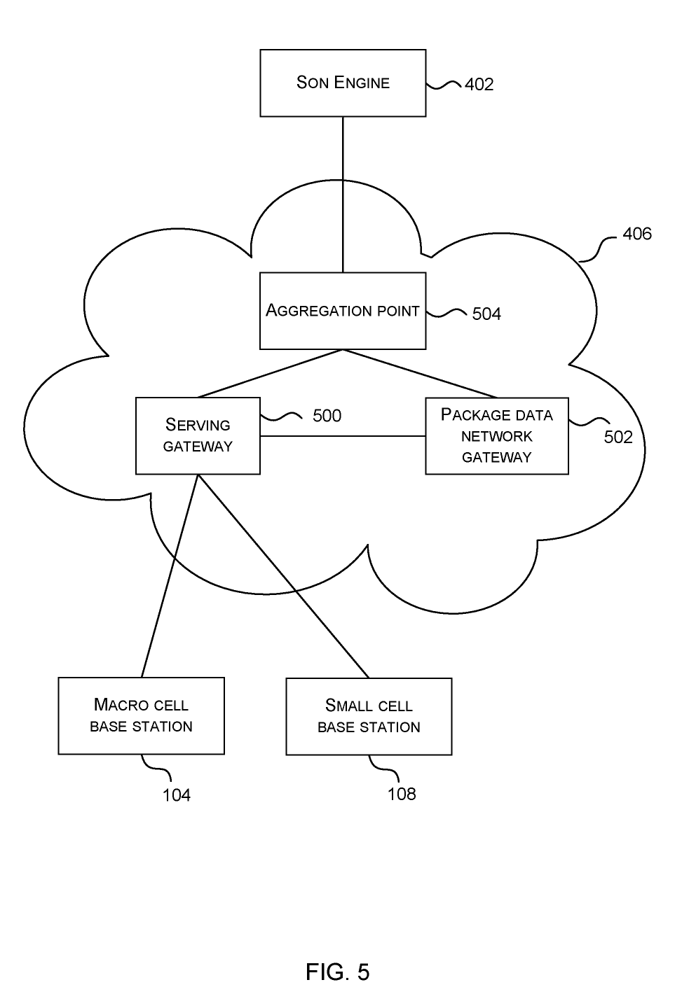

With reference to FIG. 5, the IP flow data is obtained by probing the core network 406. For example, IP flow data may be probed from a serving gateway 500 of the core network 406 and/or from a package data network gateway 502 of the core network 406 and aggregated at an aggregation point 504. The IP flow data is then transmitted directly to the SON engine 402 which is configured to abstract from the IP flow data information about the traffic load on the macro cell 100 and the small cell 102.

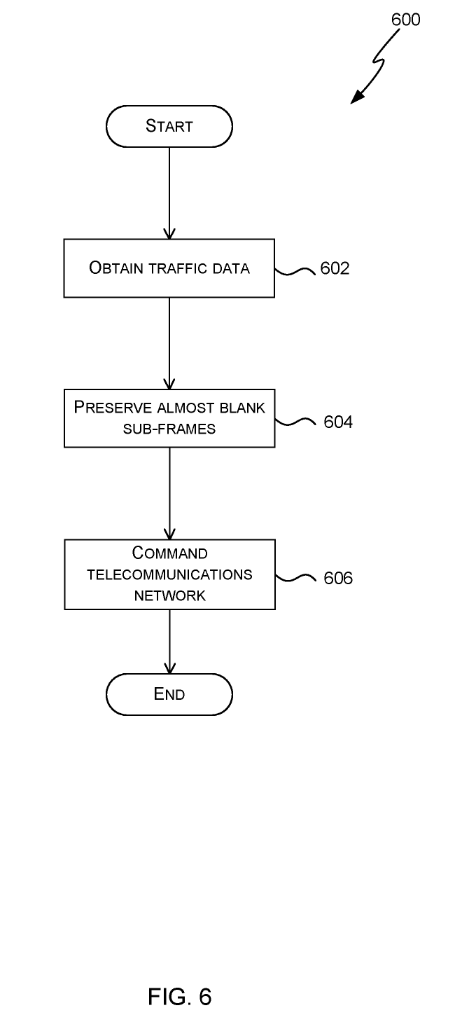

With reference to FIG. 6, a method 600 of optimizing a telecommunications network 400 comprising a macro cell 100 and a small cell 102 is performed at a SON engine 402 in accordance with an embodiment of the invention. At step 602, the SON engine obtains traffic data describing traffic in the macro cell 100 and the small cell 102. The traffic data comprises IP flow data obtained by probing a serving gateway 500 and a package data network gateway 502 of the core network 406 of the telecommunications network 400. The SON engine 402 abstracts real-time traffic load data of the macro cell 100 and the small cell 102 from the received IP flow data.

At step 604, the SON engine 402 reserves almost blank sub-frames in dependence on the abstracted traffic data. This is performed together with determining an optimal CRE power offset, also in dependence on the abstracted traffic data. The SON engine 402 optimizes ABS assignment by performing an ABS pattern algorithm such as an eICIC algorithm, and optimizes CRE power offset using a CRE algorithm. For example, this may involve increasing the number of ABSs reserved when there is an increase in traffic in the macro cell 100 and/or the small cell 102. Similarly, the CRE power offset may be increased when the macro cell 100 is overloaded to enable more user equipment devices to be handed over to the small cell 102.

At step 606, the SON engine 402 commands the telecommunications network 400 to control interference mitigation between the macro cell 100 and the small cell 102. The SON engine 402 also commands the telecommunications network 400 to control the CRE power offset of the small cell 102. The SON engine 402 commands the telecommunications network 400 to use the reserved ABSs for data transmissions to small cell edge users and to use other sub-frames for transmissions with user equipment being served by the macro cell 100 or the center of the small cell 102.

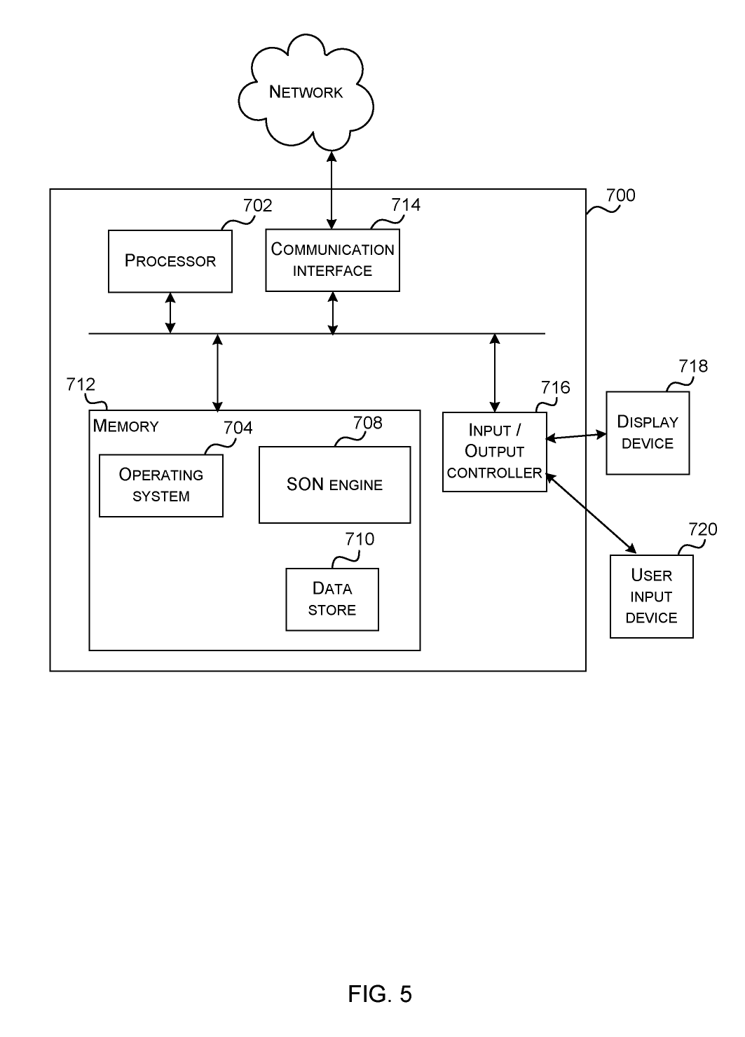

FIG. 7 illustrates various components of an exemplary computing-based device 700 which may be implemented as any form of a computing and/or electronic device, and in which embodiments of a self-organizing network engine may be implemented.

Computing-based device 700 comprises one or more processors 702 which may be microprocessors, controllers or any other suitable type of processors for processing computer executable instructions to control the operation of the device in order to receive data from an

OSS and compute optimized parameters of a telecommunications network. In some examples, for example where a system on a chip architecture is used, the processors 702 may include one or more fixed function blocks (also referred to as accelerators) which implement a part of the method of FIG. 6 in hardware (rather than software or firmware). Platform software comprising an operating system 704 or any other suitable platform software may be provided at the computing-based device to enable application software to be executed on the device. Software comprising a self-organizing network engine 706 may be provided at the computing-based device and data store 710 may hold telecommunications network parameters, network performance data, service quality indicators or other data.

The computer executable instructions may be provided using any computer-readable media that is accessible by computing based device 700. Computer-readable media may include, for example, computer storage media such as memory 712 and communications media. Computer storage media, such as memory 712, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 712) is shown within the computing-based device 700 it will be appreciated that the storage may be distributed or located remotely and accessed via a network or other communication link (e.g. using communication interface 714).

The computing-based device 700 also comprises an input/output controller 716 arranged to output display information to a display device 718 which may be separate from or integral to the computing-based device 700. The display information may provide a graphical user interface. The input/output controller 716 is also arranged to receive and process input from one or more devices, such as a user input device 720 (e.g. a mouse or a keyboard). This user input may be used to set thresholds or criteria, configure optimization algorithms, and view optimization results. In an embodiment the display device 718 may also act as the user input device 720 if it is a touch sensitive display device. The input/output controller 716 may also output data to devices other than the display device, e.g. a locally connected printing device.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A self-organizing network engine for optimizing a telecommunications network, the telecommunications network comprising a macro cell, a small cell located inside the macro cell, and the self-organizing network engine, the self-organizing network engine being configured to:
obtain traffic data describing traffic in the macro cell and in the small cell;
determine one or more almost blank sub-frames to be reserved in a transmission schedule in dependence on the traffic data; and
command the telecommunications network to:
transmit data between a base station of the small cell and cell edge users of the small cell in the almost blank sub-frames,
transmit data between a base station of the macro cell and users of the macro cell in sub-frames other than the almost blank sub-frames, and
transmit data between the base station of the small cell and cell center users of the small cell in sub-frames other than the almost blank sub-frames.

2. The self-organizing network engine of claim 1, wherein the self-organizing network engine is configured to determine one or more almost blank sub-frames to be reserved in a transmission schedule in dependence on the traffic data by:
determining from the traffic data that the traffic in the macro cell is above a threshold; and
reserving a corresponding number of almost blank sub-frames.

3. The self-organizing network engine of claim 1, wherein the self-organizing network engine is configured to optimize the number of almost blank sub-frames for reserving by using an enhanced inter cell interference coordination algorithm.

4. The self-organizing network engine of claim 1, wherein the self-organizing network engine is configured to determine a cell range expansion power offset of the small cell in dependence on the traffic data.

5. The self-organizing network engine of claim 4, wherein the self-organizing network engine is configured to determine a cell range expansion power offset of the small cell in dependence on the traffic data by:
determining from the traffic data that the traffic in the macro cell is above a threshold; and
determining a corresponding cell range expansion power offset of the small cell.

6. The self-organizing network engine of claim 4, wherein the self-organizing network engine is configured to optimize the cell range expansion power offset of the small cell by using a cell range expansion algorithm.

7. The self-organizing network engine of claim 1, wherein the self-organizing network engine is configured to abstract the traffic data from IP flow data of the telecommunications network.

8. The self-organizing network engine of claim 7, wherein the self-organizing network engine is configured to receive the IP flow data from an IP probe in a core network of the telecommunications network.

9. The self-organizing network engine of claim 8, wherein the IP probe obtains the IP flow data by probing a serving gateway of the core network.

10. The self-organizing network engine of claim 8, wherein the IP probe obtains the IP flow data by probing a package data network gateway of the core network.

11. A method of optimizing a telecommunications network comprising a macro cell and a small cell located inside the macro cell, the method comprising, at a self-organizing network engine of the telecommunications network:
obtaining traffic data describing traffic in the macro cell and in the small cell;
determining one or more almost blank sub-frames to be reserved in a transmission schedule in dependence on the traffic data; and
commanding the telecommunications network to:
transmit data between a base station of the small cell and cell edge users of the small cell in the almost blank sub-frames,
transmit data between a base station of the macro cell and users of the macro cell in sub-frames other than the almost blank sub-frames, and
transmit data between the base station of the small cell and cell center users of the small cell in sub-frames other than the almost blank sub-frames.

12. The method of claim 11, wherein the determining one or more almost blank sub-frames to be reserved in a transmission schedule in dependence on the traffic data comprises:
determining from the traffic data that the traffic in the macro cell is above a threshold; and
reserving a corresponding number of almost blank sub-frames.

13. The method of claim 11, comprising optimizing the number of almost blank sub-frames for reserving by using an enhanced inter cell interference coordination algorithm.

14. The method of claim 12, comprising determining a cell range expansion power offset of the small cell in dependence on the traffic data.

15. The method of claim 14, wherein the determining a cell range expansion power offset of the small cell in dependence on the traffic data comprises:
determining from the traffic data that the traffic in the macro cell is above a threshold; and
determining a corresponding cell range expansion power offset of the small cell.

16. The method of claim 14, comprising optimizing the cell range expansion power offset of the small cell by using a cell range expansion algorithm.

17. The method of claim 11, comprising abstracting the traffic data from IP flow data of the telecommunications network.

18. The method of claim 17, comprising receiving the IP flow data from an IP probe in a core network of the telecommunications network.

19. The method of claim 18, wherein the IP probe obtains the IP flow data by probing a serving gateway of the core network.

20. The method of claim 18, wherein the IP probe obtains the IP flow data by probing a package data network gateway of the core network.

21. One or more computer-readable storage media having stored thereon computer-readable instructions which, when executed by one or more processors of a computing system, cause the computing system to perform a method according to claim 11.
